(19) United States
(12) Patent Application Publication
(10) Pub. No.: US 2011/0276390 A1
(43) Pub. Date: Nov. 10, 2011

(54) SELECTING ADVERTISEMENTS FOR PRESENTATION WITH SEARCH RESULTS

(75) Inventors: Xiaolei Li, Kirkland, WA (US); Raman Chandrasekar, Seattle, WA (US); Dou Shen, Redmond, WA (US)

(73) Assignee: Microsoft Corporation, Redmond, WA (US)

(21) Appl. No.: 12/774,739

(22) Filed: May 6, 2010

(51) Int. Cl. G06Q 30/00

(52) U.S. Cl. 705/14.42; 705/14.54

(57) ABSTRACT

This patent application pertains to selecting advertisements for presentation with search results. One example includes receiving a user's search query. This example also includes selecting an advertisement that is relevant for presentation to the user with search results for the search query. The advertisement is selected from a set of advertisements by comparing a semantic context of individual advertisements to a semantic context of the user's search query.

### BACKGROUND

The patent application relates to user web searches. Presenting advertisements with search results can be very valuable. For instance, when a user enters a search query, an advertisement(s) (“ad”) can be identified that is potentially relevant to the search query. The search results and the ads can both be presented to the user. Users tend to like the ads if the ads are relevant to the user's search. Users tend not to like ads that are irrelevant to their search. Advertisers tend to have a similar perspective; i.e., they want their ads to be shown to interested users.

### SUMMARY

This patent application pertains to selecting advertisements for presentation with search results. One example includes receiving a user's search query. This example also includes selecting an advertisement that is relevant for presentation to the user with search results for the search query. The advertisement is selected from a set of advertisements by comparing a semantic context of individual advertisements to a semantic context of the user's search query. To summarize, the present concepts can correlate ads with search queries in a manner that contributes to the satisfaction of both the user and the advertiser.

The above listed example is provided for introductory purposes and does not include all of, and/or limit, the claimed subject matter.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1 and 5 are flow charts for accomplishing semantic relatedness concepts in accordance with some implementations.

FIGS. 2 and 4 illustrate semantic relatedness examples in accordance with some of the present concepts.

FIG. 3 illustrates some of the components of FIG. 2 in greater detail.

### DETAILED DESCRIPTION

### Overview

This patent application pertains to user web search queries and more particularly to selecting ads for presentation with search results for those web searches. Ads can be associated with keywords. The keywords can be utilized to match a user's search terms with one or more ads. For instance, is there a match between the search terms and the ad's keywords? Often, there are many ads that have keywords that overlap or match with the user's search terms. However, not all of these ads are relevant to the user's search. The present concepts pertain to semantic relatedness tools for enhancing the relevance of ads selected for a particular search. The term “tool” can be thought of as covering systems and/or methods. In some instances, semantic relatedness tools can utilize a semantic context to select relevant ads for a search query. The term “semantic context” will be described below by way of example.

Recall from above that ads can be associated with keywords to aid in matching the ad to a particular search query. For instance, in one hypothetical example, an advertiser like Home Depot™, which is a home improvement/hardware retailer, may select the keyword “window” and the keyword “curtain”. Another advertiser such as Best Buy™, which is an electronics retailer, may also select the keyword “window” and also the keyword “XP”. (Real corporate entities and products are utilized in some of the present examples to aid the reader with real world search scenarios. No association is implied between the Assignee of the present application and these entities).

Simply matching a search term to a keyword may produce unsatisfactory results. For instance, a user who enters a search of “windows vista” is just as likely to be matched with a Best Buy ad as a Home Depot ad since each contains a keyword match to the search term “window”. Yet, it is likely that the user is referring to the software product “Windows Vista” offered by Microsoft® Corporation. This product or related products are likely to be sold by Best Buy and unlikely to be sold by Home Depot. The present semantic relatedness tools can aid matching the relevant ad with a user's search and/or excluding less relevant or irrelevant ads. Toward this end, some implementations can utilize the semantic context to select relevant ads for a user's web search.

Briefly, a semantic context can be anything related to an ad or advertiser that can contribute to enhancing the relevance of ads selected for presentation with results of a search. For instance, the semantic context may look at ad data, such as keywords associated with an ad or advertiser, negative keywords, and content of the ad. For example, an ad can consist of a title, body copy (together these two may be called ad copy) and a URL (the ‘landing page’) where the user who clicks on the ad is taken. An advertising order typically includes a bid amount (the amount the advertiser is willing to pay to the search engine when a user clicks the ad), the bid keywords and one or more ads. Some or all of this ad data can be utilized in the semantic context. Further, rather than comparing individual search query terms to individual keywords, the present techniques may compare the semantic context of the search query terms to the semantic context of the ad data. A relevance of the search query and the ad based upon comparing their respective semantic contexts can be more accurate than relevance determined using existing techniques.

### First Semantic Relatedness Example

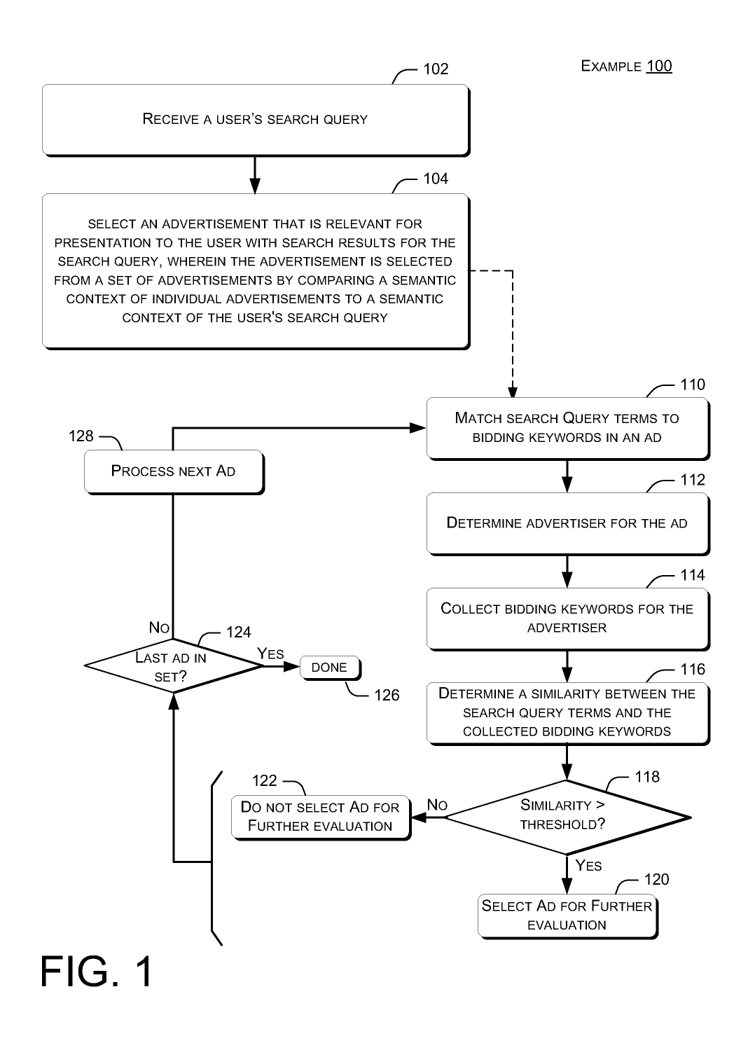

FIG. 1 shows a semantic relatedness tool example 100. In this example, at 102, a user's search query is received. The search query can include one or more terms that are either manually entered by the user, auto-completed for the user, or otherwise suggested to the user.

At 104, an ad is selected that is relevant for presentation to the user with search results for the search query. The ad can be selected from a set of ads by comparing a semantic context of individual ads to the semantic context of search query terms.

One example for accomplishing the selecting of block 104 is described below relative to blocks 110-128. Preliminarily, in some models, an advertiser can ‘bid’ against other advertisers for individual keywords, thus the term ‘bid keywords’. For instance, continuing with the above example, an advertiser like Home Depot™ may bid on the keyword “window” and the keyword “curtain”. Another advertiser such as Best Buy™ may also bid on the keyword “window” and also on the keyword “XP”. Thus, a bid keyword taken in isolation can yield poor relevance. For example, advertisers from both Best Buy and Home Depot may bid on the same keyword “window”, but Best Buy's advertising intent relates to operating systems and Home Depot's relates to home furnishings. While bid keywords are utilized in this example for sake of brevity and ease of explanation, other implementations may not employ the bid model and as such can function with ‘standard keywords’ and/or other types of ad data.

At block 110, search query terms are matched to bid keywords in an ad. In one case, a database of all available ads can be established (e.g., the “set” of ads introduced above relative to block 104). The database of available ads can list all of the bid keywords associated with one or more of the ads. The database can then map which bid keywords occur in which ads. Accordingly, comparing the search term(s) to the database of available ads can separate candidate ads (i.e. ads which have at least one bid keyword that matches at least one search term) from other ads which don't have a match. Stated another way, filtering can be performed to separate candidate ads from a remainder of the set of ads. Continuing with the above example where the user entered “windows vista”, assume that block 110 returns two candidate ads. (For ease of explanation, singular and plural forms of a search term, such as “window” and “windows” are not distinguished in this discussion, but may be in some implementations).

At block 112, the advertiser for the ad is determined. Recall from above that the database of available ads can map keywords to ads. In some implementations, the database of available ads can also map ads to advertisers. In this case, two ads were returned at block 110 as candidate ads. Assume for purposes of explanation that the database indicates that one of the ads belongs to Home Depot and the other to Best Buy. Accordingly, the remaining blocks 114-128 can be performed for each of these two advertisers. No further resources need be employed evaluating other ads and/or advertisers. As such, from one perspective the other ads and/or advertisers can be treated as ‘pruned’ from further consideration.

Block 114 collects bid keywords for the advertiser. Bid keywords can be thought of as keywords that the advertiser considers to be valuable for matching searches to their ads. The bid keywords may include all, more, less or different keywords than the bid keywords of a particular one of the advertiser's ads. The bid keywords may also be maintained in the database and mapped to the advertisers.

Block 116 determines a similarity between the search terms and the collected bid keywords of the ad. (As noted above for sake of brevity this example utilizes only bid keywords. Other examples can determine the similarity utilizing factors that can contribute to the semantic relatedness, beyond or in place of bid keywords). Various techniques can be utilized for determining similarity. Some of these techniques are explored below. Of note here is that the similarity can be based upon all of the collected bid keywords or a subset thereof rather than a single bid keyword taken in isolation.

Block 118 compares the similarity to a threshold. In an instance where the similarity is greater than the threshold, the example proceeds to block 120 and can select the ad for further evaluation for potential presentation to the user with the search results. Otherwise, this example proceeds to block 122 and does not select the ad for further evaluation. To summarize, comparing the similarity to the threshold can further reduce the number of ads that are further evaluated for presentation to the user. Regardless of whether the similarity satisfies the threshold at block 118, (i.e., yes or no at block 118), the semantic relatedness tool can proceed to block 124. Block 124 determines whether the ad is the last ad in the database. If so, the tool can finish at 126. If the ad is not the last ad in the database, the tool can process the next ad in the database as indicated at 128 by returning to block 110.

### Second Semantic Relatedness Example

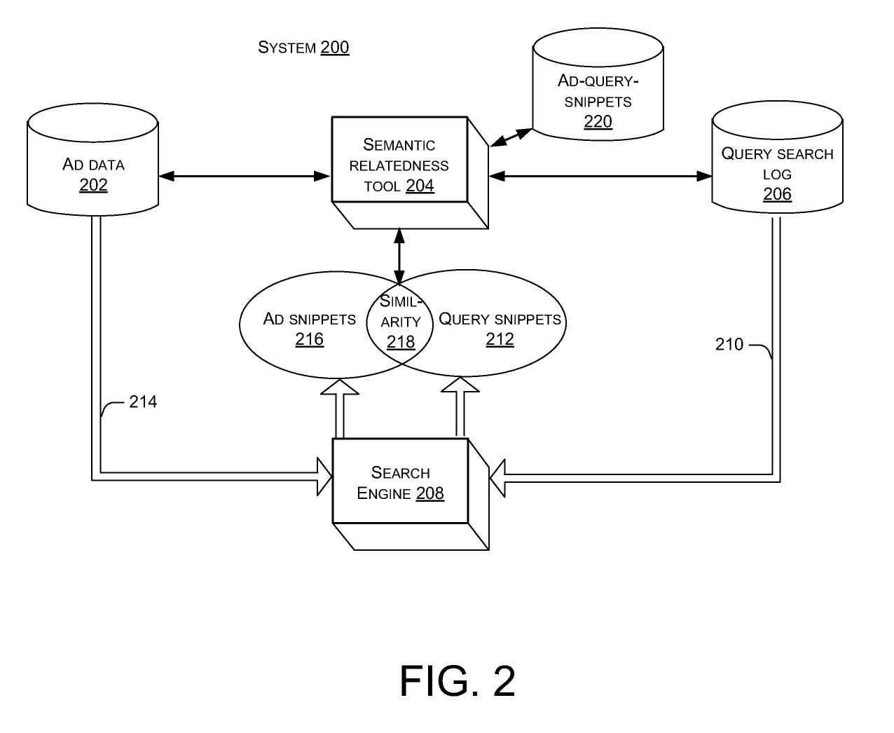

FIG. 2 shows a system 200 in which semantic relatedness can be employed. In this example, system 200 includes an ad data database 202, a semantic relatedness tool 204, a query search log database 206, and a search engine 208. System 200 can operate at query time, but will be explained in the context of performing at least some functions prior to query time to reduce latency experienced by a user.

Ad data database 202 can include data associated with individual ads, such as a listing of each keyword that has been bid upon by one or more advertisers. Query search log database 206 can include a listing of users' previous queries. The query search log database will often include millions or even billions of entries. In this case, semantic relatedness tool 204 can access query search log database 206. The semantic relatedness tool 204 can retrieve individual queries, such as for example “windows vista” from the query search log database. The semantic relatedness tool may retrieve every query from the query search log database 206. In other cases, the semantic relatedness tool may apply some type of constraint to limit the number of retrieved queries. For example, the semantic relatedness tool may apply a frequency constraint. For instance, the frequency constraint may only retrieve queries that occur at least one thousand times per month, or some other value. Such a configuration can reduce resource usage on queries that occur very infrequently.

The semantic relatedness tool 204 can also access the ad data database 202 and identify ads that in some way match the search query, such as having bid keywords that match one or more terms of the query, such as “windows” and/or “vista”. The semantic relatedness tool may however, exclude ads that have negative keywords that match one of more of the query terms whether or not the ad has a keyword that matches a query term. Briefly, a negative keyword can be one that the advertiser determines tend to lead to erroneous ad matching. For instance, Home Depot might decide that “windows” is a keyword that they want to bid on, but that they don't want their ads to be presented if one of the other search query terms is “xp” since such users tend not to click on the Home Depot ad when presented.

The semantic relatedness tool 204 can send the individual query to search engine 208 as indicated at 210. The semantic relatedness tool can obtain the search results from the search engine and extract snippets from the search results (i.e., query snippets 212). Similarly, the semantic relatedness tool can send the ad data, such as bid keywords of an individual identified ad (or advertiser) from ad data database 202 to search engine 208 as indicated at 214. The semantic relatedness tool can obtain the search results from the search engine and extract the snippets from the search results (i.e., ad snippets 216). Finally, the semantic relatedness tool can determine a similarity 218 between the query snippets 212 and the ad snippets 216.

The semantic relatedness tool can also compare the similarity 218 to a threshold as explained relative to FIG. 1 to determine whether to select the ad for presentation with the search query results. The semantic relatedness tool 204 can repeat this process for each ad that potentially matches a search query.

In some implementations, the semantic relatedness tool can move to the next search query in the query search log 206 and repeat the process for the entire query search log. In this manner, the semantic relatedness tool can build an ad-query-snippets database 220 of individual ads to present with individual search queries. Thus, the ad-query-snippets database can show a correlation between a query and an ad or advertiser as a similarity score. In some cases, the ad-query-snippets database can rank individual ads and/or advertisers relative to an individual search query based upon their similarity score.

This ad-query-snippets database 220 can be built in advance so that it is available at query time to reduce system latency in presenting search results and ads to the user. In such a configuration, when a user enters a search query the semantic relatedness tool 204 can access the ad-query-snippets database to identify the ad (or ads) that are relevant for presentation with the search results for the search query. For instance, the presented ads may be those with the highest similarity scores relative to the user's query.

While the above example can be thought of as determining a semantic context as the similarity 218 between the query snippets 212 and the ad snippets 216, other implementations can consider other factors in the semantic context. For example, other features that may be considered can include the fact that advertisers can be thought of as placing ‘orders’ where they bid on specific terms or keywords. The advertisers want their ads shown when a user searches on the ordered ‘bid keywords’. The advertiser may also specify whether they want ads to be shown only if the query is an Exact Match, or if it's acceptable that the query is a Broad Match—a substring, superstring or conceptual variant of the query.

Alternatively or additionally, ads that satisfy the similarity threshold may be further sorted using features such as a bid amount associated with a bid keyword for a given advertiser, an anticipated click-through rate (what fraction or number of users who see this ad will click on it) and other features based on the publisher quality, etc.

In summary, one potential goal of semantic relatedness tool 204 is to increase the relevance of paid search advertisements by promoting good matches (and inhibiting bad matches) of ads to user's queries with bid keywords.

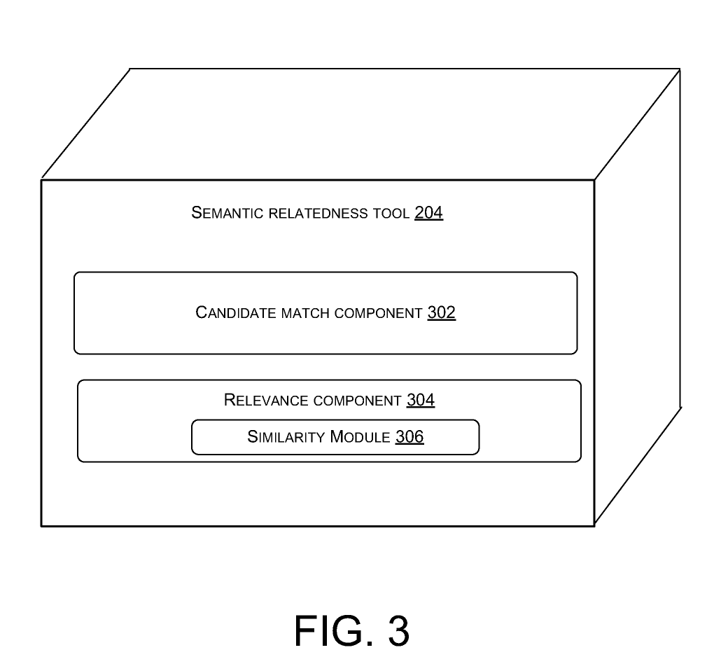

FIG. 3 shows one implementation of semantic relatedness tool 204 in greater detail. In this case, the semantic relatedness tool includes a candidate match component 302 and a relevance component 304. The relevance component can employ a similarity module 306.

In some implementations, candidate match component 302 can be thought of as offering a pruning function in that it can separate ads that include a keyword that matches a search term from those that do not (e.g., candidate ads from non-candidate ads).

The candidate ads can be sent to relevance component 304. The relevance component can score the candidate ads utilizing the semantic context which is described above and below. In this particular configuration the relevance component utilizes similarity module 306 to score the candidate ads. Recall that various types of ad data can contribute to the semantic context of an ad. Examples of ad data can include, keywords, bid keywords, super keywords, ad content, etc. Super keywords can be thought of as a set of keywords that include at least one term from the search query. For instance, “Windows XP®” may be a super keyword for the search term “windows”.

One or more functions can be applied to the ad data to determine the semantic context. One example where the ad data relates to super keywords is now described. In this example, let function super(k, o) return the set of bid keywords from order o that contain k as a substring; call these superkeywords of k in o. Example: super(“windows”, o₁)={“windows decoration”, “windows shades”, “windows blinds”, . . . }. In this example, Relevance(q, k, o)==Relevance(q, super(k, o)). The similarity module 306 can evaluate the similarity of each super keyword to the query. The similarity module can extract a metric over all these similarity numbers. The similarity module can use this metric as the similarity of the query to the order (for that keyword). For example, the similarity module can utilize the formula:

Relevance(q,super(k,o))=max_{kiεsuper(k,o)}(CosineSimilarity(SearchSnippet(q),SearchSnippet(kᵢ)))

If this similarity metric is above a threshold, then the similarity module 306 can select the advertisement order o for the query q. If this metric is below the threshold (i.e. if the query is not sufficiently similar to the order), then the similarity module can ensure that the order will not be matched to this query. Note that the above listed cosine similarity function is provided for purposes of explanation. Other types of similarity functions can be utilized in various implementations.

In one implementation the similarity module 306 can employ a similarity function where for a query q, order o, and keyword k, the similarity module can compute similarity sim(a,b), where a and b are strings, and where ‘a’ is one of:
Query q: just the query itself
Query Snippets(q): the concatenation of the top N result snippets returned by search engine on the search results page for the query q.
Query+AdText(o): the query concatenated with the ad title, ad body and ad url of the order o.

And ‘b’ is one of:
SuperKeywords (k,o): keywords in o that contain the string k,
SuperKeyword Snippets(k,o): snippets (as defined for Query Snippets above) of the SuperKeywords,
SuperText(o): the concatenation of SuperKeywords(k,o); just one long text string,
OrderKeywords(o): all bid keywords(o), or
OrderText(o): the concatenation of all bid keywords(o), to form a long string

In addition,
+AdText: any of the ‘b’ strings may also be catenated with the ad title, ad body and url.

The function f is a cosine (distance) function. Wherever ‘b’ has multiple elements (as in superkeywords, orderkeywords, etc.), the similarity module 306 can compute this function for each element, and take the minimum, maximum, average, and/or median values over all the multiple elements. In general, some performant implementations can use the ‘max’ of the computed values. As noted above, the present concepts can be implemented with other types of similarity functions.

Among other configurations, these implementations can utilize one of:
QuerySnippets and SuperTextSnippets
Query and SuperText
QuerySnippets and SuperText
Query and SuperText plus AdText

Any of these similarity functions can be used, based on problem requirements and limits on key performance indicators. The approach can be generalized to use any combination of available information, including bid keywords, super-keywords, ad copy, ad landing page, snippets, etc.

Thus, in the above configurations, the semantic relatedness tool 204 utilizes a semantic context rather than a single term to define the relevance of an ad or an advertiser. Stated another way, the set of terms that constitute the bid keywords is a better model of the advertiser's intent than a search query term considered in isolation.

### Third Semantic Relatedness Example

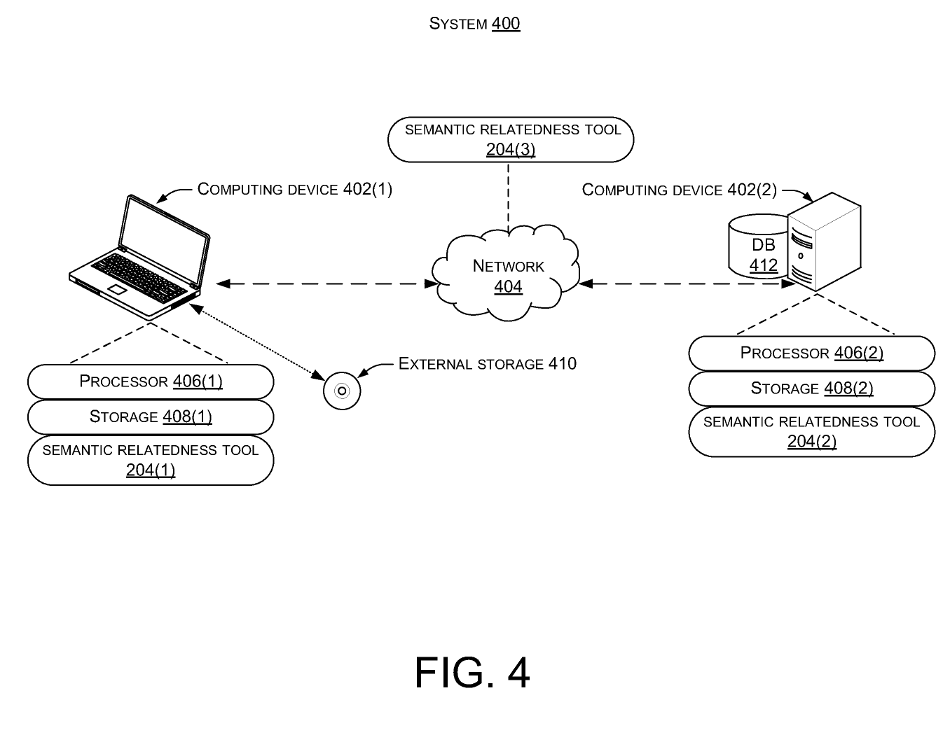

FIG. 4 shows a system 400 that is configured to accomplish the semantic relatedness concepts described above and below. In this case, system 400 includes first and second computing devices 402(1) and 402(2). The computing devices can exchange data over a network 404. Individual computing devices can function in a stand-alone or cooperative manner to achieve semantic relatedness.

In this case, each of computing devices 402(1) and 402(2) can include a processor 406, storage 408, and a semantic relatedness tool 204.

Processor 406 can execute data in the form of computer-readable instructions to provide a functionality. Data, such as computer-readable instructions can be stored on storage 408. The storage can include any one or more of volatile or non-volatile memory, hard drives, and/or optical storage devices (e.g., CDs, DVDs etc.), among others. The computing devices 402 can also be configured to receive and/or generate data in the form of computer-readable instructions from an external storage 410. Examples of external storage mechanisms can include optical storage devices (e.g., CDs, DVDs etc.), hard drives, and flash storage devices (e.g., memory sticks or memory cards), among others. The computing devices may also receive data in the form of computer-readable instructions over network 404 that is then stored on the computing device for execution by its processor.

Semantic relatedness tool 204 can be configured to receive a user's search that includes one or more terms and to select an ad to present to a user with results of the search.

As mentioned above, either of computing devices 402(1) and 402(2) can function in a stand-alone configuration. For instance, semantic relatedness tool 204(1) can exist on computing device 402(1). The bid keyword database 202, query search log database 206, and ad-snippets database 220 (each shown in FIG. 2) could be manifest on external storage 410. In such a case, a user query can be entered on computing device 402(1). The semantic relatedness tool 204(1) can utilize the bid keyword database 202, query search log database 206, and ad-snippets database 220 in combination with accessing a search engine (not shown) over network 404 to identify relevant ads for the user's search. The semantic relatedness tool 204(1) can then cause the search results and relevant ads to be presented to the user on computing device 402(1).

In another scenario, the semantic relatedness tool 204(1) can be resident on computing device 402(1) which is engaged by the user. The bid keyword database 202, query search log database 206, and ad-snippets database 220 can be stored on database 412 associated with remote computing device 402(2). The semantic relatedness tool can receive a search from the user and access database 412 to select ads. In this configuration, though not specifically shown, the search engine may also be associated with computing device 402(2).

In still another scenario, computing device 402(1) can be a thin computing device with limited storage and/or processing resources. In such a case, processing and/or data storage can occur on computing device 402(2) (and/or upon a cloud of unknown computers connected to network 404). Results of the processing can then be sent to and displayed upon computing device 402(1) as search results and associated relevant ads. Toward this end, semantic relatedness tool 204(3) can be thought of as a cloud implementation that is accessible via network 404 but the physical location of which may not be readily apparent.

The term “computing device” as used herein can mean any type of device that has some amount of processing capability. Examples of computing devices can include traditional computing devices, such as personal computers, cell phones, smart phones, personal digital assistants, or any of a myriad of ever-evolving or yet to be developed types of computing devices. Further, a system can be manifest on a single computing device or distributed over multiple computing devices.

### Semantic Relatedness Method Example

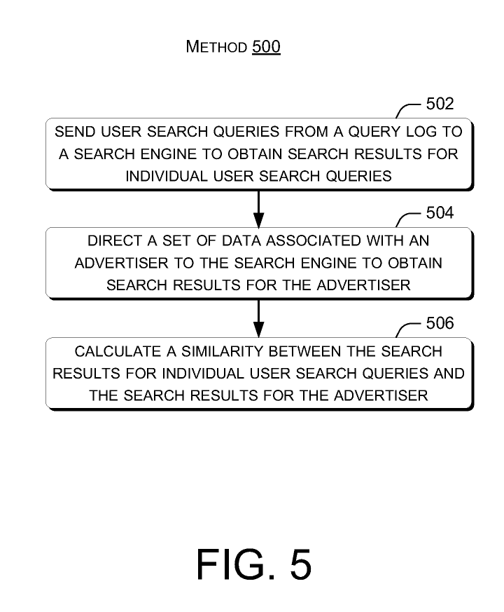

FIG. 5 illustrates a flowchart of a process, technique, or method 500 that is consistent with at least some implementations of the present semantic relatedness concepts. Among other uses, method 500 can be utilized to generate an ad-snippets database that can be accessed at query time.

Block 502 sends user search queries from a query log to a search engine to obtain search results for individual user search queries.

Block 504 directs a set of data associated with an advertiser to the search engine to obtain search results for the advertiser. For instance, the set of data can include at least one keyword that matches a term of an individual search query of block 502. The set of data can include some or all of the keywords associated with an advertiser. In some cases, the set of data can alternatively or additionally include ad text from an advertisement associated with the advertiser, metadata associated with the advertiser, or a combination of bid keywords associated with the advertiser and non-keyword data associated with the advertiser.

Block 506 calculates a similarity between the search results for individual user search queries and the search results for the advertiser. In some implementations, this calculation can be accomplished by calculating the similarity between snippets of the search results for an individual user search query and snippets of the search results for the advertiser. Blocks 502-504 can be repeated for other ads or advertisers to create an ad-snippets database. The ad-snippets database can then be accessed upon receipt of a user query.

The order in which the above listed methods are described is not intended to be construed as a limitation, and any number of the described blocks or acts can be combined in any order to implement the method, or an alternate method. Furthermore, the method can be implemented in any suitable hardware, software, firmware, or combination thereof such that a computing device can implement the method and/or cause the method to be implemented. In one case, the method is stored on a computer-readable storage media as a set of instructions such that execution by a computing device causes the method to be performed.

In summary, the above described semantic relatedness concepts can provide enhanced correlation between user and advertiser. Some of the semantic relatedness implementations can correlate the user's search query and an ad or advertiser based upon a semantic context that offers a more accurate correlation than previous techniques.

### CONCLUSION

Although techniques, methods, devices, systems, etc., pertaining to semantic relatedness are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A computer-readable storage medium having instructions stored thereon that when executed by a computing device causes acts to be performed, comprising:
receiving a user's search query; and,
selecting an advertisement that is relevant for presentation to the user with search results for the search query, wherein the advertisement is selected from a set of advertisements by comparing a semantic context of individual advertisements to a semantic context of the user's search query.

2. The computer-readable storage medium of claim 1, wherein the selecting comprises filtering the set of advertisements into candidate advertisements and non-candidate advertisements and wherein the comparing comprises comparing a similarity between a function of the semantic context of an individual advertisement and a function of the semantic context of the user's search query, and further comprising ranking the candidate advertisements based upon the similarity, and wherein the selection is based at least in part on the ranking.

3. The computer-readable storage medium of claim 2, wherein the comparing comprises obtaining snippets for the search query and obtaining snippets for keywords of the individual advertisements, and wherein the comparing is performed on the search query snippets and the keyword snippets.

4. The computer-readable storage medium of claim 3, wherein the comparing comprises computing the similarity between the search snippets for the search query and the search snippets for the keywords of the individual advertisements, and ranking the individual advertisements by similarity score.

5. The computer-readable storage medium of claim 1, wherein the semantic context considers one or more of the following relative to an individual advertisement: keywords, bid keywords, super-keywords, ad copy, ad landing page, snippets, or negative keywords.

6. A computer-readable storage medium having instructions stored thereon that when executed by a computing device causes acts to be performed, comprising:
sending user search queries from a set of queries to a search engine to obtain search results for individual user search queries;
directing a set of data associated with an advertisement to the search engine to obtain search results for the advertisement; and,
calculating a similarity between the search results for individual user search queries and the search results for the advertisement.

7. The computer-readable storage medium of claim 6, wherein the set of data comprises all bid keywords associated with the advertisement.

8. The computer-readable storage medium of claim 6, wherein the directing a set of data associated with the advertisement occurs in an instance where the set of data includes all bid keywords that match a term of the search query and wherein the advertisement is not associated with a negative keyword that occurs in the search query.

9. The computer-readable storage medium of claim 6, wherein the directing a set of data comprises directing one or more of: all bid keywords associated with the advertisement, some bid keywords associated with the advertisement, advertisement text from the advertisement, metadata associated with the advertisement, or a combination of bid keywords associated with the advertisement and non-keyword data associated with the advertisement.

10. The computer-readable storage medium of claim 6, wherein the similarity comprises the similarity between snippets of the search results for an individual user search query and snippets of the search results for the advertisement.

11. The computer-readable storage medium of claim 6, further comprising comparing the calculated similarity to a similarity threshold.

12. The computer-readable storage medium of claim 6, further comprising repeating the sending, directing, and calculating for other advertisements.

13. A system, comprising:
a semantic relatedness tool configured to receive a user's search that includes one or more terms and to select an ad that is relevant for presentation to a user with results of the search, the semantic relatedness tool comprising:
a candidate match component configured to identify ads that include at least one keyword that matches an individual term from the user's search; and,
a relevance component configured to determine a correlation between individual identified ads and the search terms by comparing a function of a set of keywords from the individual identified ad to the one or more terms of the search.

14. The system of claim 13, wherein the candidate match component is further configured to exclude ads that include a negative keyword that matches the individual term or another individual term from the user's search.

15. The system of claim 13, wherein the function is configured to determine a semantic context of the set of keywords.

16. The system of claim 13, wherein the relevance component is configured to utilize a similarity module to determine the correlation based upon a similarity function and wherein the similarity module is configured to rank the individual identified ads based upon respective similarities.

17. The system of claim 13, wherein the relevance component is configured to compare snippets of the set of keywords and snippets of the one or more terms of the search.

18. The system of claim 17, wherein the relevance component is configured to send the set of keywords and the one or more terms to a search engine to obtain the snippets of the set of keywords and snippets of the one or more terms of the search.

19. The system of claim 17, wherein the relevance component is configured to access an ad-query-snippet database to obtain the snippets of the set of keywords and snippets of the one or more terms of the search.

20. The system of claim 13, wherein the system comprises a single computing device, and wherein the single computing device includes a processor and wherein the semantic relatedness tool is executed on the processor.
